(19) United States
(12) Patent Application Publication
(10) Pub. No.: US 2009/0019672 A1
(43) Pub. Date: Jan. 22, 2009

(54) Clipboard with improved ergonomics

(76) Inventor: Christopher Herbert Moore, Belmont, MA (US)

Correspondence Address: Christopher Herbert Moore, 44 Oak Ave., Belmont, MA, 02478, US

(21) Appl. No.: 12/218,608

(22) Filed: Jul. 16, 2008

Related U.S. Application Data
(60) Provisional application No. 60/959,722, filed on Jul. 17, 2007.

(51) Int. Cl. B42F 5/00

(52) U.S. Cl. 24/67.3

(57) ABSTRACT

An apparatus for writing or drawing on paper or pads of paper held by a clipboard, the clipboard allowing the paper or pad to be moved upward by the user to maintain support for his or her writing hand as the user writes down the page. The pad-holding clamp is placed along the longer left edge of the clipboard so that it cannot interfere with the pad as the user raises it to and beyond the top edge of the clipboard, Previous designs placed the clamp on the top narrow edge of the panel, where it constitutes an obstruction that prevents the user from moving the pad up. Spring clips that snap into place provide the clamping force required to keep the pad from slipping, and rubber grip strip on leading edge, underside of the clamp and extending the length of the clamp holds even a single sheet firmly.

### CROSS REFERENCE TO RELATED APPLICATIONS

This application is based on provisional application Ser. No. 60/959,722, filed on Jul. 17, 2007.

An apparatus for writing or drawing on paper or pads of paper held by a clipboard, said clipboard allowing the paper or pad to be moved upward by the user to maintain support for his or her writing hand as the user writes down the page

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of office supplies/writing accessories/clipboards and more specifically to an apparatus for writing or drawing on paper or pads of paper held by a clipboard, said clipboard allowing the paper or pad to be moved upward by the user to maintain support for his or her writing hand as the user writes down the page.

Clipboards are used as portable writing surfaces in situations where it is impossible to have a normal writing surface. These situations include airplanes, airport waiting lounge, any room of the home, outdoor job site, police CSI and accident scenes, surveys, petition drives, doctor's offices, and hospitals and sporting events. In all these situations, the clipboard provides a portable, temporary, transportable writing desk.

Typically, the clipboard is loaded with a pad of paper formatted for “portrait” use. Formatting of a typical pad includes ruler lines in light blue ink, and a guide line in light red running near the left long side. By convention, the pad is clamped at the top, where the sheets are glued together, along the narrow dimension (8½″ dimension in the USA). To load a pad of paper, the user opens the clamp by squeezing the clamp, slides the pad up against the stop, and releases her grip to secure the pad.

Nearly all clipboards are intended to be used with vertical (portrait mode) paper pads, and their clamps are at the upper end where they grip the bound end of the pad.

### BRIEF SUMMARY OF THE INVENTION

The primary object of the invention is to provide consistent hand and wrist support while writing or drawing over the entire pad of paper.

Another object of the invention is to be lightweight yet stiff for ease of packing and carrying for example in a computer carrying bag.

Another object of the invention is to be only slightly larger than the pad or paper sheet used with the clipboard.

A further object of the invention is to feel warm or neutral to the touch.

Yet another object of the invention is to be only slightly thicker than the pad or paper sheet used with the clipboard.

Still yet another object of the invention is to grip the paper or pad firmly, whether the thickness is that of one sheet or a pad.

Another object of the invention is to be easy to open the paper clamp by squeezing with thumb against the clamp's top surface and the panel backing.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for writing or drawing on paper or pads of paper held by a clipboard, said clipboard allowing the paper or pad to be moved upward by the user to maintain support for his or her writing hand as the user writes down the page comprising: pad-holding clamp is placed along the longer left edge of the clipboard so that it cannot interfere with the pad as the user raises it to and beyond the top edge of the clipboard, Clamp and panel are laminated with interior channels which accommodate spring clips that constitute the hinge that holds the clamp and panel together, Spring clips that snap into place provide the clamping force required to keep the pad from slipping, and rubber grip strip on leading edge, underside of the clamp and extending the length of the clamp holds even a single sheet firmly.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a section view showing the embedded spring clip in its pockets

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

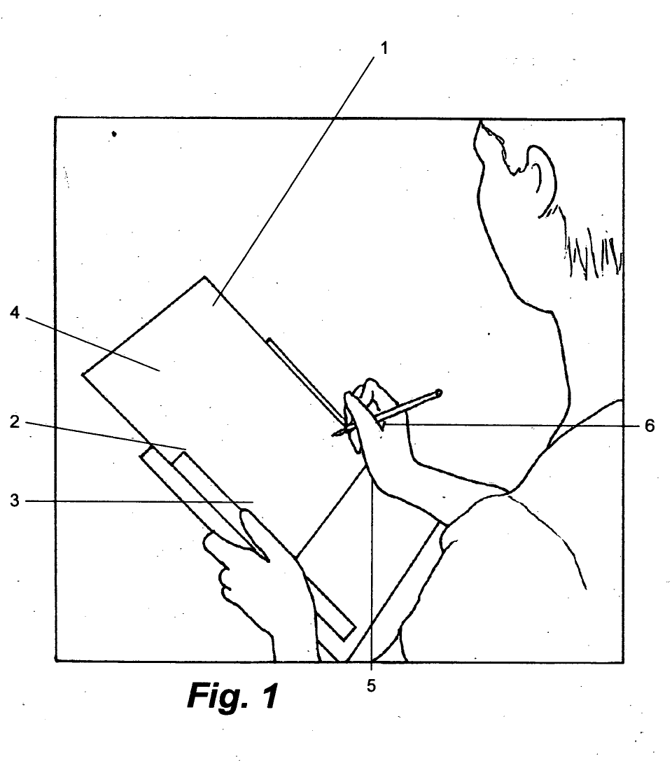

Turning first to FIG. 1 there is shown a user with clipboard in her lap and with pad raised to above the panel top edge to maintain good hand support for her writing down the page. In earlier clipboard designs, the clamp here shown at the left edge of the pad would be at the top edge and the user would have no recourse to the raised pad solution to the hand support problem. In FIG. 1—

1) Pad has been moved upward and the hand is fully supported
2) Clamp is low profile and broad for easy operation
3) Press the left edge of the clamp to release the paper.
4) Writing area can be placed anywhere on the panel by suitable selection of pad position.
5) With the pad moved upward, panel area is exposed, permitting relaxed and un-cramped writing. When the pad is moved upward it extends beyond the support of the panel, but this is of no consequence.
6) Right-handed writer shown. For a left-handed writer, rotate the clipboard 180 degrees to place the clamp along the right-hand edge, out of the way.

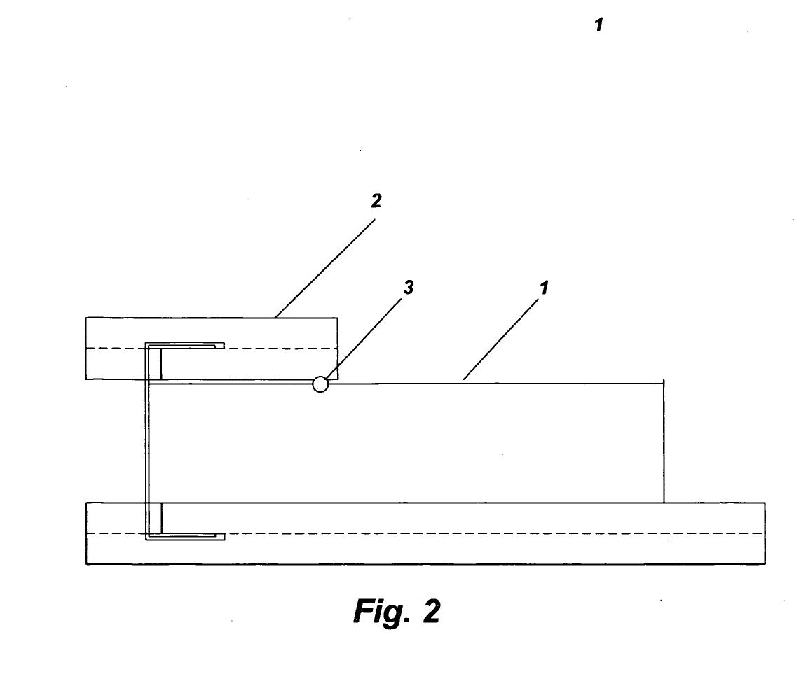

Turning to the drawing in FIG. 2 there is shown a view through the cross-section of the apparatus, showing clamp, clip, and panel

1) Panel, laminated two ply formica, approximately 9.0×12×0.062 inches, with slots for spring clips.
2) Clamp, laminated two ply formica, approximately 1.5×9.0×0.062 inches, with slots for spring clip.
3) Grip strip applied to right hand clamp edge provides a polymer “sticky” surface improving grip on paper sheets.

While there are many ways to realize the invention of this patent, one embodiment has been chosen as preferred. Some variations of implementation of the invention are easily grasped and imagined; nevertheless the essence of this invention survives its inclusion with a variety of materials and clamp designs.

For example, the panel (typically for A4 or 8.5×11 inch US size) could be made of thin plywood, masonite, formica, carbon filament sheet, aluminum sheet, and various kinds of plastic.

Likewise, the clamp could also be made of thin plywood, masonite, formica, carbon filament sheet, aluminum sheet, and various kinds of plastic. The clamp and panel need not be of the same material.

Although the Preferred Embodiment of this invention was realized with laminated formica, any of the listed or unlisted materials could be used within the limitations of good design practice.

Paper and pads of paper sheets glued along one edge come in various sizes and aspect ratios. Although 8½×11 inch pads are used in this application, the invention is valid at other sizes and aspect ratios. For example, Europe uses a slightly different sheet size, A4. Furthermore, 11×17 inch (A5 in Europe) pads can be accommodated by slight alteration of the panel and clamp sizes.

Moreover, some horizontally designed pads—such as columnar or calendar forms—may be used in landscape mode (glued pad edge is the long side of the pad). For pads of this type, the clamp would be placed on the left (short) side of the panel.

The gripping strip is secured to the underside of the clamp's inner edge and provides increased grip so that even a single sheet will be held firmly in place. While the gripping strip can be made with a variety of cross sections (square, rectangular, wedge, circle, oval, U or right angle), a right angle cross section is used for the Preferred Embodiment. Whatever cross section is chosen, it can fit into an envelope of 0.125×0.125 inches. The gripping strip should be non-staining black rubber or other suitable material.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for writing or drawing on paper or pads of paper held by a clipboard, said clipboard allowing the paper or pad to be moved upward by the user to maintain support for his or her writing hand as the user writes down the page comprising:
Pad-holding clamp is placed along the longer left edge of the clipboard so that it cannot interfere with the pad as the user raises it to and beyond the top edge of the clipboard;
Clamp and panel are laminated with interior channels which accommodate spring clips that constitute the hinge that holds the clamp and panel together;
Spring clips that snap into place provide the clamping force required to keep the pad from slipping; and
Rubber grip strip on leading edge, underside of the clamp and extending the length of the clamp holds even a single sheet firmly.
